(19) United States
(12) Patent Application Publication
(10) Pub. No.: US 2025/0373574 A1
(43) Pub. Date: Dec. 4, 2025

(54) INTERACTIONS BETWEEN ASSISTANT-TYPE AGENTS

(71) Applicant: OpenAI OpCo, LLC., San Francisco, CA (US)

(72) Inventor: Noah Deutsch, San Francisco, CA (US)

(73) Assignee: OpenAI OpCo, LLC., San Francisco, CA (US)

(21) Appl. No.: 18/678,808

(22) Filed: May 30, 2024

(51) Int. Cl. H04L 51/02; H04L 51/046

(52) U.S. Cl. CPC H04L 51/02; H04L 51/046

(57) ABSTRACT

The present technology pertains to having AI agent instances interacting with each other on behalf of different user accounts. For example, the present technology addresses a user experience for a user account interacting with an AI agent instance. The present technology also addresses the limits of permission or authority of a generative response engine instance. The present technology also addresses mechanisms of consent by a user account to be contacted by a generative response engine instance.

### BACKGROUND

Generative response engines such as language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation. Generative response engines can sift through vast amounts of text data, extract context, and provide coherent responses to a wide array of queries.

### BRIEF DESCRIPTION OF THE SEVERAL VIEWS OF THE DRAWINGS

Details of one or more embodiments of the subject matter described in this disclosure are set forth in the accompanying drawings and the description below. However, the accompanying drawings illustrate only some typical embodiments of this disclosure and are therefore not to be considered limiting of its scope. Other features, embodiments, and advantages will become apparent from the description, the drawings, and the claims.

FIG. 1 illustrates an example system for facilitating interaction between at least two AI agent instances interacting with each other on behalf of different user accounts in accordance with some embodiments of the present technology.

FIG. 2 illustrates an example method for interacting with a sender AI agent instance to complete a task on behalf of a first user account in accordance with some embodiments of the present technology.

FIG. 3 illustrates an example method for looking up a recipient user account address in accordance with some embodiments of the present technology.

FIG. 4 illustrates an example method for generating a plan and determining that the AI agent instance has permission to execute the plan in accordance with some embodiments of the present technology.

FIG. 5 illustrates an example method for processing a message by the recipient AI agent instance in accordance with some embodiments of the present technology.

FIG. 6 illustrates an example sender user account interaction with the sender AI agent instance occurring in sender user account front end in accordance with some embodiments of the present technology.

FIG. 7A, FIG. 7B, and FIG. 7C illustrates examples of recipient user account interaction with the recipient AI agent instance occurring in the recipient user account front end in accordance with some embodiments of the present technology.

FIG. 8 illustrates a more robust system for facilitating interaction between at least two AI agent instances interacting with each other on behalf of different user accounts in accordance with some embodiments of the present technology.

FIG. 9 is a block diagram illustrating an exemplary machine learning platform for implementing various embodiments of this disclosure in accordance with some embodiments of the present technology.

FIG. 10 is a block diagram of an example transformer in accordance with some embodiments of the disclosure.

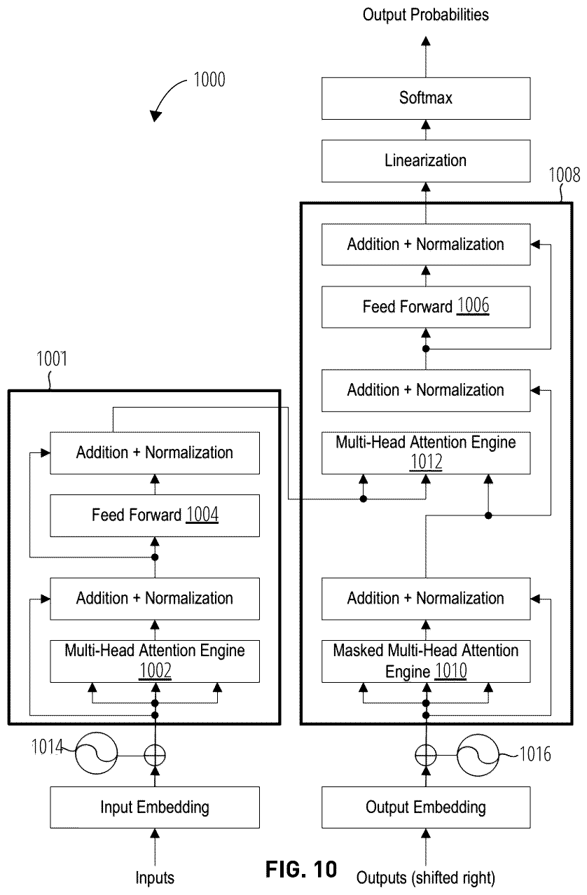

FIG. 11 illustrates an example lifecycle of an ML model in accordance with some embodiments of the present technology.

FIG. 12 shows an example of a system for implementing certain embodiments of the present technology.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

Generative response engines such as language models represent a significant milestone in the field of artificial intelligence, revolutionizing computer-based natural language understanding and generation. Generative response engines, powered by advanced deep learning techniques, have demonstrated astonishing capabilities in tasks such as text generation, translation, summarization, and even code generation.

Generative response engines are a class of artificial intelligence tools that can generate responses to prompts. Many generative response engines provide a conversational user interface powered by a chatbot whereby the user account interacts with the generative response engine through natural language conversation with the chatbot. Such a user interface provides an intuitive format to provide prompts or instructions to the generative response engine. In fact, the conversational user interface powered by the chatbot can be so effective that users can feel as if they are interacting with a person. Some user accounts find the generative response engine effective enough that they want to utilize the conversational user interface powered by the chatbot as they would an assistant.

Because of their astonishing capabilities, users see the potential for generative response engines to be an AI agent and help users complete tasks.

While even less sophisticated technologies than generative response engines have unlocked the ability for software to be an agent for a user or a business, at least on specific tasks, such software agent technologies have not achieved the type of software agent interactions that users desire.

One reason that AI agents are not a reality is that the implementation is far more complicated than the concept. An AI agent acting on behalf of a user is complicated because, as users, we interact with other users. And, while it is ego-centric, many users only contemplate what they want the AI agent to do for them, without putting enough thought into the other side of the transaction.

When a user desires an AI agent to help with a task, users often overlook that there are additional challenges even for purely communication tasks. Namely, there is a reasonable probability that if one user has an AI agent instance helping them with a task, that the recipient of the communication might also have an AI agent instance helping them. In this example, the challenge of an AI agent acting as an assistant for a particular user is transformed into a challenge of having AI agent instances interacting with each other on behalf of different user accounts.

When viewed through the lens of having AI agent instances interacting with each other on behalf of different user accounts, there are challenges in the principal (user account)—AI agent interaction experience, in determining the AI agent's permission or authority to act, and in determining whether consent exists from the recipient of a communication to interact with or through an AI agent, etc.

The present technology aims to address these and other challenges associated with having AI agent instances interacting with each other on behalf of different user accounts. For example, the present technology addresses a user experience for a user account interacting with an AI agent instance. The present technology also addresses the limits of permission or authority of an AI agent instance. The present technology also addresses mechanisms of consent by a user account to be contacted by an AI agent instance, among other challenges.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

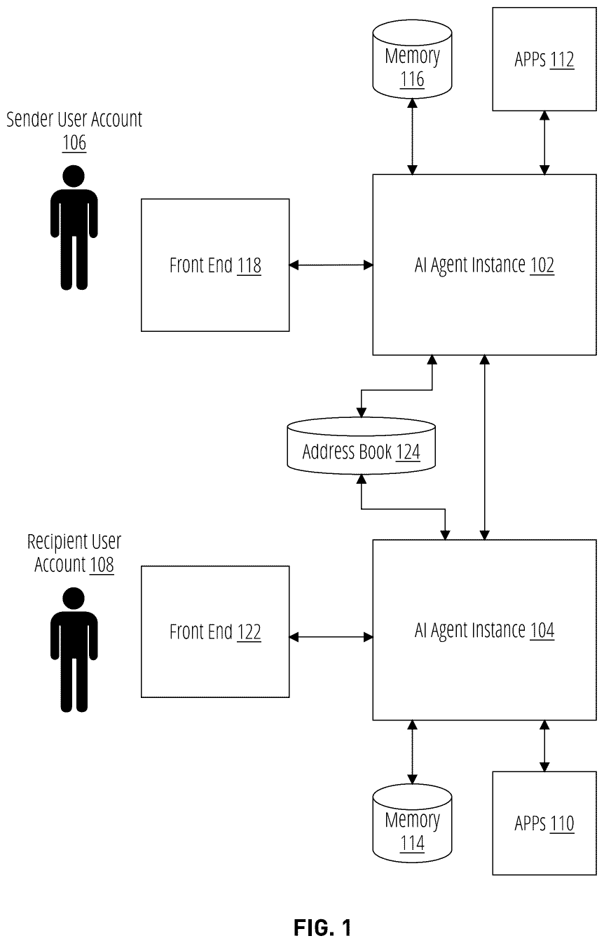

FIG. 1 illustrates an example system for facilitating interaction between at least two AI agent instances interacting with each other on behalf of different user accounts in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

FIG. 1 illustrates a sender user account 106 interacting with sender AI agent instance 102 through sender user account front end 118. Sender AI agent instance 102 can act as an AI agent on behalf of sender user account 106. As addressed herein, sender user account 106 can request help with a task that involves coordinating with recipient user account 108.

As used herein, reference to a user account can refer to a user that has a user account that provides access to their respective AI agent instance. Thus, reference to a user account can refer to the human associated with the user account and/or the system instances and data associated with the user account.

Recipient user account 108 can also have a recipient AI agent instance 104 acting as an AI agent on its behalf. Just like sender user account 106, recipient user account 108 can interact with recipient AI agent instance 104 through recipient user account front end 122.

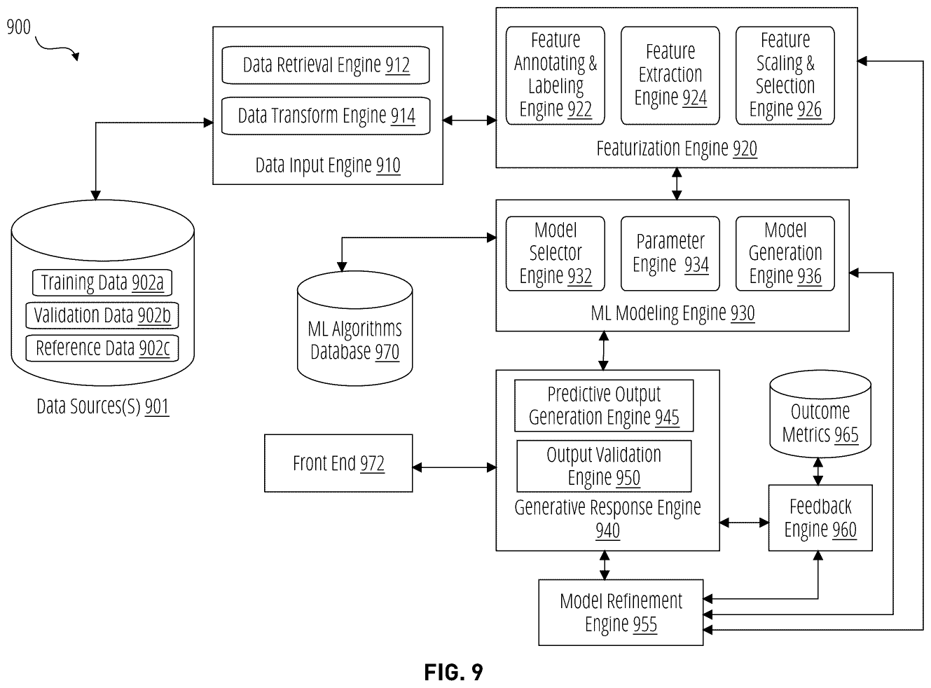

In some embodiments sender AI agent instance 102 and recipient AI agent instance 104 are instances of generative response engine 940, and sender user account front end 118 and sender user account front end 118 are instances of front end 972 illustrated in FIG. 9. In some embodiments, respective AI agent instances do not need to be instances of the same generative response engine, from the same developer, or hosted by the same organization.

In furtherance of the task provided by sender user account 106 sender AI agent instance 102 can interact with recipient AI agent instance 104. As addressed herein, in some embodiments, the respective AI agent instances (102, 104) can exchange communications between each other, but they cannot interact with a user of a user account for which they are not the AI agent.

FIG. 1 also illustrates an address book 124. Address book 124 can be used by sender AI agent instances when they receive an instruction to perform a task by interacting with a person identified by their name rather than their user account identifier or contact address. Accordingly, the AI agent instance can have access to address book 124 to look up contact information for users. In some embodiments, address book 124 can also include information regarding whether or not a user utilizes an AI agent instance as an assistant. When sender AI agent instance determines that a recipient user account has a recipient AI agent instance, the sender AI agent instance can address messages to the recipient AI agent instance.

While FIG. 1 illustrates address book 124 being reachable by respective AI agent instances (e.g., AI agent instance 102 and 104), this is just one implementation, and it may be that different instances of AI agents have access to their own address books.

FIG. 1 also illustrates that the sender AI agent instance 102 can have access to one or more sender user account apps 112. Likewise, recipient AI agent instance 104 can have access to one or more recipient user account apps 110. In particular, user account can provide access to some apps like a calendar application, a document management system, a workflow application, etc., to their respective AI agent instance. In this way, the respective AI agent instances can at least learn more information about a user account's context, and in some instances can take actions using these apps on behalf of the user account. In some embodiments, the respective AI agent instance might access the respective apps through sender user account front end 118 or recipient user account front end 122.

FIG. 1 also illustrates that sender AI agent instance 102 having access to sender user account memory 116 and recipient AI agent instance 104 having access to recipient user account memory 114. The sender user account memory 116 and recipient user account memory 114 are memory files used to record information learned from user accounts through usages of the respective AI agent instance. In some embodiments, these memory files can include selected facts that the respective AI agent instance has deemed worthy of saving. In some embodiments, these memory files can be a more robust database of documents and a record of past interactions between a user and their AI agent instance that can be searched when needed. In some embodiments, the AI agent instances can use respective memory files to answer questions or handle tasks without needing to prompt a user because the information is already in the memory file.

Greater detail about the components in FIG. I will become apparent from the description to follow.

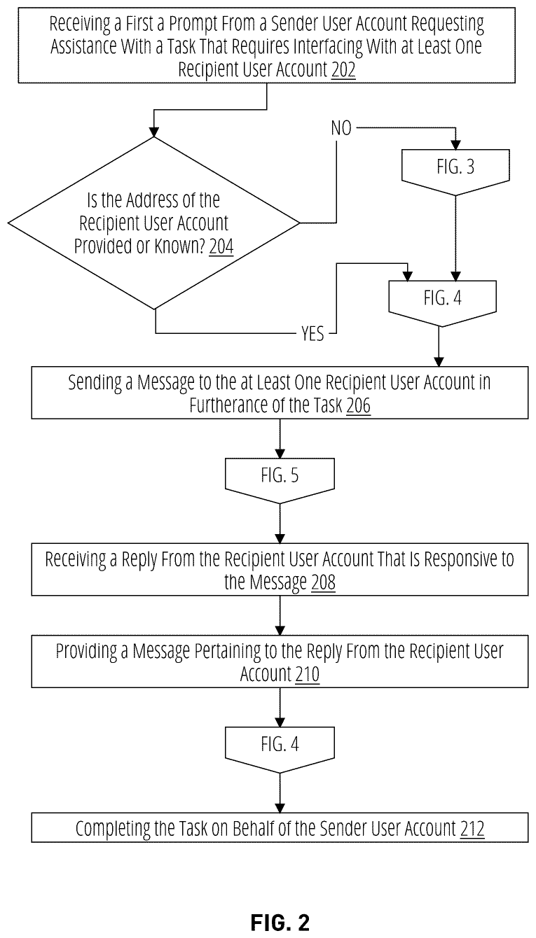

FIG. 2 illustrates an example method for interacting with a sender AI agent instance to complete a task on behalf of a first user account in accordance with some embodiments of the present technology. Although the example method depicts a particular sequence of operations, the sequence may be altered without departing from the scope of the present disclosure. For example, some of the operations depicted may be performed in parallel, may be excluded or added, or may be performed in a different sequence that does not materially affect the function of the method. In other examples, different components of an example device or system that implements the method may perform functions at substantially the same time or in a specific sequence.

According to some examples, the method includes receiving a first prompt from a sender user account requesting assistance with a task that requires interfacing with at least one recipient user account at block 202. For example, the sender AI agent instance 102 illustrated in FIG. 1, which acts as a personal assistant to the sender user account, may receive a first prompt from a sender user account requesting assistance with the task that requires interfacing with at least one recipient user account. For instance, sender user account 106 might ask sender AI agent instance 102 for help with scheduling a meeting with recipient user account 108 by providing a natural language input into sender user account front end 118.

In some embodiments, the at least one recipient user account also utilizes an AI agent instance as a personal assistant (e.g., recipient AI agent instance 104). Therefore, the request from the sender user account becomes something like a “have your people call my people” situation, wherein the sender user account's AI agent and the recipient user account's AI agent will interact to accomplish the task on behalf of their respective principals (sender user account 106 and recipient user account 108).

Throughout this description, the sender user account's AI agent is often referred to as sender AI agent instance, and the recipient user account's AI agent is often referred to as recipient AI agent instance. This phraseology should not be used to limit the present technology to an environment where all AI agents need to be an instance of the same generative response engine. In some embodiments, respective AI agents (AI agent instances) do not need to be instances of the same generative response engine, from the same developer, or hosted by the same organization.

To complete the task initiated by the sender user account, sender AI agent instance 102 first must figure out who the recipient user account is. When communicating in natural language, users don't usually spell out user account identifiers. Instead, they are more likely to refer to a user by name. This is especially true if the sender user account is communicating with sender AI agent instance 102 using voice as a communication modality. When using written language, such as typing, it might be more common for the user account to identify the recipient user account using @ mentions or through autocomplete functionality that might suggest user accounts resembling a name that is being typed. Both @ mentions and autocomplete are features built into sender user account front end 118, and are efficient ways to address messages to known user accounts.

Additionally, sender user account memory 116 can store information about recipient user account to which sender user account communicates most often. Thus, by referencing sender user account memory 116, sender AI agent instance 102 may be able to match a recipient's name with their user account identifier.

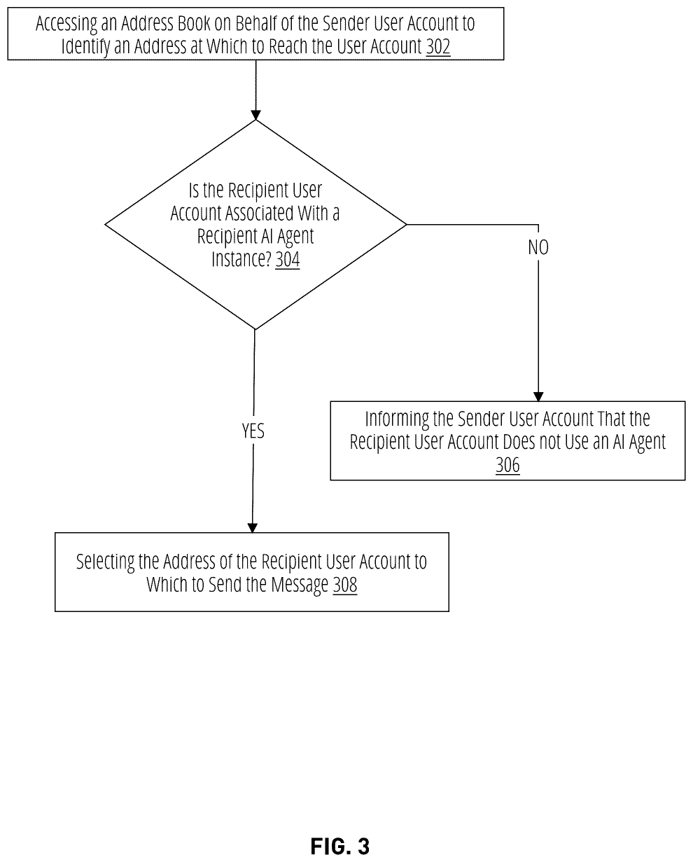

However, sender AI agent instance 102 won't always be able to identify a recipient user account identifier using the methods addressed above. Accordingly, in some examples, the method includes determining whether an address (or user account identifier) of the recipient user account was provided by the sender or known to sender AI agent instance 102 at decision block 204. When the address of the recipient user account is not known, the method proceeds to FIG. 3.

FIG. 3 illustrates an example method for looking up a recipient user account address in accordance with some embodiments of the present technology. Although the example method depicts a particular sequence of operations, the sequence may be altered without departing from the scope of the present disclosure. For example, some of the operations depicted may be performed in parallel, may be excluded or added, or may be performed in a different sequence that does not materially affect the function of the method. In other examples, different components of an example device or system that implements the method may perform functions at substantially the same time or in a specific sequence.

According to some examples, the method includes accessing an address book on behalf of the sender user account to identify an address at which to reach the recipient user account at block 302. For example, the sender AI agent instance 102 illustrated in FIG. 1 may access address book 124 on behalf of the sender user account to identify an address at which to reach the recipient user account 108.

While, on one hand, the method illustrated in FIG. 3 is a typical address database look up, one wrinkle is that sender AI agent instance 102 should determine whether the recipient user account utilizes an AI agent, such as recipient AI agent instance 104. According to some examples, the method includes determining whether the recipient user account is associated with a recipient AI agent instance at decision block 304. For example, the sender AI agent instance 102 illustrated in FIG. 1 may determine whether recipient user account 108 is associated with recipient AI agent instance 104.

One reason why it is important for the sender AI agent instance to learn about whether the recipient user account uses an AI agent is that, in some embodiments, it is undesirable to allow an AI agent such as sender AI agent instance to be permitted to have unchecked permissions to communicate with a human user of the recipient user account. In some embodiments, the sender AI agent instance is configured to be able to communicate with the human user of the sender user account and the recipient AI agent instance, but not the human user of the recipient user account.

Of course, it is technically possible and feasible for the sender generative response engine instance to communicate directly with the human user of the recipient user account, and such communication is explicitly contemplated by the present technology. However, in some embodiments, it might provide a better user experience to limit the communication of the sender AI agent instance with the human user of the recipient user account.

Accordingly, when sender AI agent instance looks up the recipient user account at block 302 and determines at decision block 304 that the recipient user account does not have an AI agent associated with the account, the method can proceed to block 306, wherein sender AI agent instance 102 can inform the sender user account that the recipient user account does not use an AI agent. In this scenario, sender AI agent instance 102 can still assist sender user account 106 with the task by composing messages for sender user account 106, but might ask sender user account 106 to review and approve before they are sent to recipient user account 108.

When an entry in the address book 124 indicates that the recipient user account is associated with an AI agent, according to some examples, the method includes selecting the address of the recipient user account to which to send the message at block 308. For example, the sender AI agent instance 102 illustrated in FIG. 1 may select the address of the recipient user account to which to send the message. As will be addressed herein, direct AI agent-to-AI agent interaction can take place even though the address of the recipient user account is the address of the human user of the recipient user account by enabling recipient AI agent instance 104 to intercept messages sent from other AI agents.

In some embodiments, an alternate addressing scheme could also be used wherein an entry in the address book for the recipient user account includes an address to reach a recipient AI agent instance acting as a personal assistant on behalf of the recipient user account. In some embodiments, the selecting the address of the recipient user account to which to send the message at block 308 can involve sender AI agent instance 102 selecting the address of recipient AI agent instance 104 to send a message directly to the AI agent of the recipient user account. It can then be up to recipient AI agent instance 104 to communicate any embodiments of the communication to the human user of recipient user account 108.

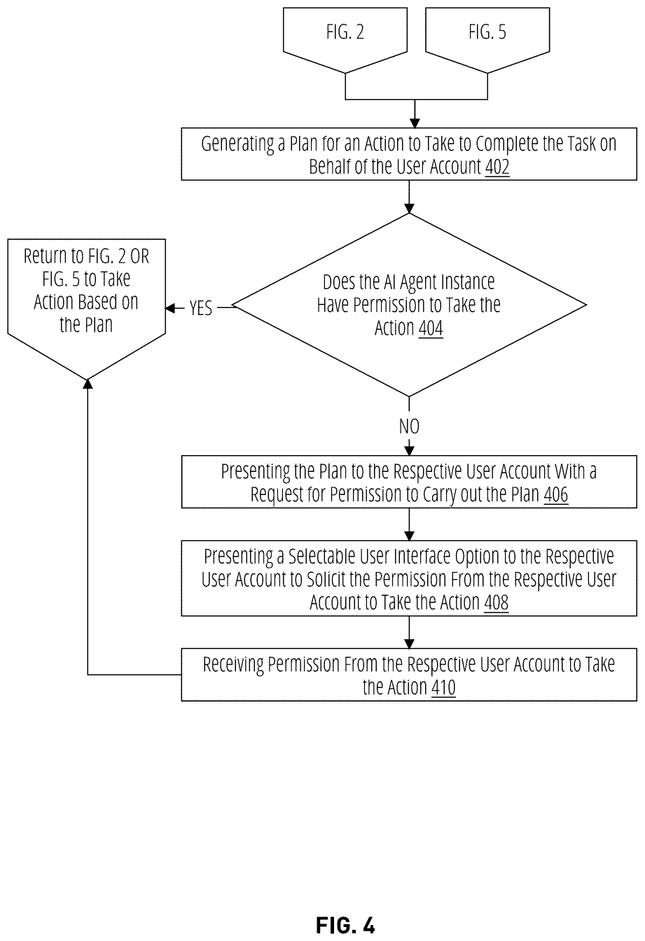

Once an address at which to communicate with the recipient user account is known by sender AI agent instance 102, the method proceeds to FIG. 4.

FIG. 4 illustrates an example method for generating a plan and determining that the AI agent instance has permission to execute the plan in accordance with some embodiments of the present technology. Although the example method depicts a particular sequence of operations, the sequence may be altered without departing from the scope of the present disclosure. For example, some of the operations depicted may be performed in parallel, may be excluded or added, or may be performed in a different sequence that does not materially affect the function of the method. In other examples, different components of an example device or system that implements the method may perform functions at substantially the same time or in a specific sequence.

As the present technology utilizes AI agents to carry out tasks on behalf of a user account, it is important to the objective of providing a good user experience that the AI agents do not overstep their boundaries and take actions that would make the user account uncomfortable. Even if the example where sender user account 106 requests sender AI agent instance 102 to find a time to meet with recipient user account 108, it might be that sender user account 106 would not want sender AI agent instance 102 to go so far as to put a meeting on the calendar.

In some embodiments, the boundaries a particular user account might want to put on their AI agent could vary by user account. To accommodate the variability of an amount of delegation a particular user account wishes to provide to its AI agent, the present technology addressed a mechanism by which AI agents can remember permissions and authority delegated to them.

While the description to follow may refer to the sender AI agent instance 102 preparing to send a communication to recipient user account 108, it should be appreciated that FIG. 4 is equally applicable to both sender AI agent instance 102 and recipient AI agent instance 104. FIG. 4 applies to any AI agent of the present technology when it generates a plan and then determines if it has permission to execute the plan.

According to some examples, the method includes generating a plan for an action to take to complete the task on behalf of the user account at block 402. For example, the respective AI agent instance (e.g., AI agent instance 102 or 104) may generate a plan for an action to take to complete the task on behalf of the user account.

The respective AI agent instance can receive a prompt and generate a response in the form of a plan. For example, the prompt could be sender user account 106 asking for help setting up a meeting with recipient user account 108. The plan could be to write to recipient user account 108 requesting to schedule the meeting and learn of times that recipient user account 108 might be free for a meeting. Or the plan could be to write to recipient user account 108 requesting a meeting and offering to provide temporary access to a calendar of sender user account 106 to recipient user account 108. In another example, the prompt could be the request from the sender user account 106 received by the recipient user account 108, whereby recipient AI agent instance 104 could generate a plan to respond with the availability of the recipient user account.

According to some examples, the method includes determining whether the AI agent instance has permission to take the action at decision block 404. For example, the respective AI agent instance (e.g., AI agent instance 102 or 104) may determine whether the AI agent instance has permission to take the action. While decision block 404 refers to permission, this decision is more about determining whether a user account would want to be consulted. Of course, when an AI agent does not have permission, it is inherent that the user account wants to be consulted, but a user account might also want to be consulted even when the respective AI agent instance technically has permission. An example of this might occur when the respective AI agent instance has permission to create meetings on a user account's calendar, but the respective AI agent instance might determine that the user account would likely want to be consulted about specific details concerning a meeting that the respective AI agent instance wants to add to the calendar.

The respective AI agent instance can determine whether it has permission to take action using a combination of techniques. First, the respective AI agent instance can be trained to ask for permission by training on a dataset of plans labeled with a desired action to request permission or act without requesting permission.

Second, the respective AI agent instances have access to a memory file associated with the respective user account that is configured to store persistent permissions given to the respective AI agent instance. The respective AI agent instance can determine if the generated plan is covered by permissions already granted to the respective AI agent instance. The memory file can be available to the respective AI agent instance as it determines to request permission.

Additionally, the respective AI agent instance can learn from explicit decisions to grant or deny permission to the respective AI agent instance during use. In this way, the respective AI agent instance can learn interaction preferences for the user account.

Using some or all of these techniques, the respective AI agent instance can become personalized to the respective user account and can learn its boundaries regarding permission or authority to act.

In some embodiments, the respective AI agent instance could need to ask for permission to send a message to a recipient user account, access data of the sender user account, or access an app utilized by the respective user account to complete the task on behalf of the respective user account.

When the respective AI agent instance determines it does not have permission to carry out its plan, according to some examples, the method includes presenting the plan to the respective user account with a request for permission to carry out the plan at block 406. For example, the respective generative response engine instance (e.g., AI agent instance 102 or 104) may present the plan to the respective user account with a request for permission to carry out the plan.

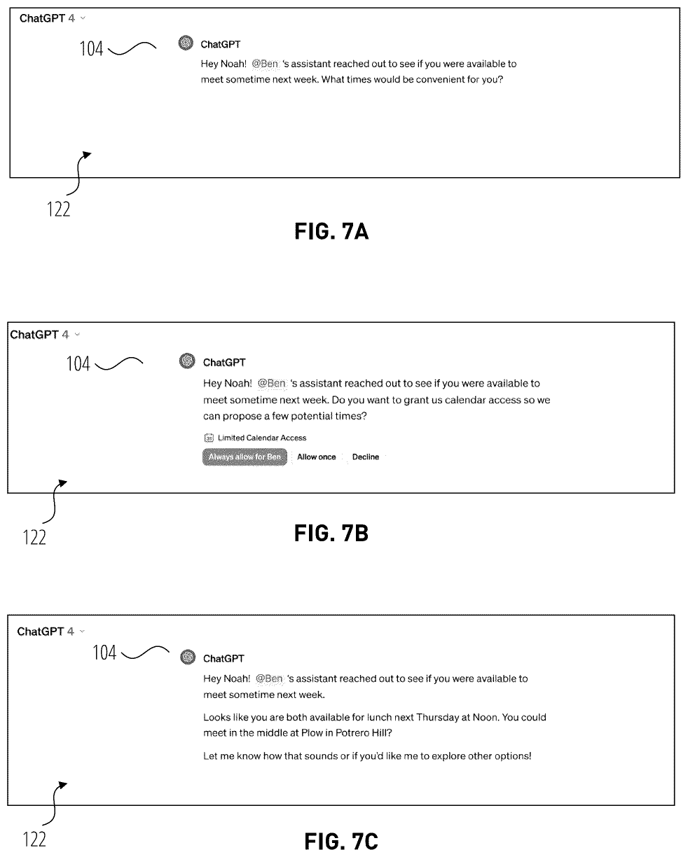

According to some examples, the method includes presenting a selectable user interface option to the respective user account to solicit the permission from the respective user account to take the action at block 408. For example, the respective AI agent instance (e.g., AI agent instance 102 or 104) may present a selectable user interface option to the respective user account to solicit permission from the respective user account to take the action. Not all types of permission will lend itself to presenting a selectable user interface option, but when they can be provided, the selectable user interface option can make it easier for the respective user account to give or deny permission. An example of the selectable user interface option is illustrated in FIG. 7B.

Whether through a natural language input or through a selection of the selectable user interface option, according to some examples, the method includes receiving permission from the respective user account to take action at block 410. For example, the respective AI agent instance (e.g., AI agent instance 102 or 104) may receive permission from the respective user account to take the action.

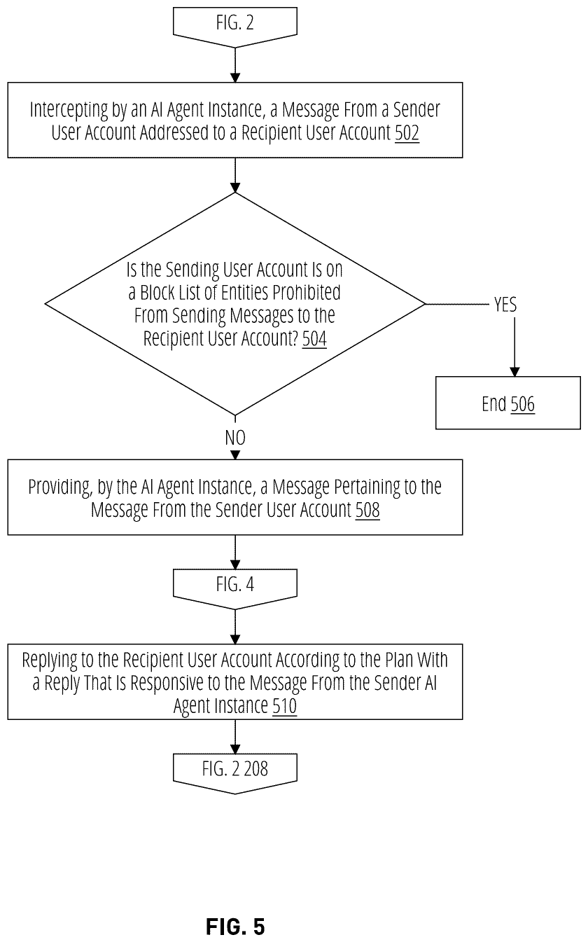

When the respective AI agent instance determines it has permission to carry out the plan, according to some examples, the method includes returning to FIG. 2 or FIG. 5 to take action based on the plan.

Returning to FIG. 2, according to some examples, the method includes sending a message to the at least one recipient user account in furtherance of the task at block 206. For example, the sender AI agent instance 102 illustrated in FIG. 1 may send a message to the at least one recipient user account in furtherance of the task.

In some embodiments, the message from the sender AI agent instance to the recipient user account identifies the sender AI agent instance as an author of the message or at least identifies that the message is from an autonomous AI agent. For example, the message can include metadata that indicates that the message is from an autonomous AI agent, or the autonomous AI agent can identify itself in the message. This can be particularly important in embodiments wherein messages are sent to the recipient user account without differentiation of whether the message is sent to the human user of the recipient user account or the recipient AI agent instance 104 so that the recipient generative response engine instance 104 can unambiguously intercept messages that were generated by an agent.

After sending the message by sender AI agent instance 102, the method turns to FIG. 5 where recipient AI agent instance 104 receives the message.

FIG. 5 illustrates an example method for processing a message by the recipient AI agent instance in accordance with some embodiments of the present technology. Although the example method depicts a particular sequence of operations, the sequence may be altered without departing from the scope of the present disclosure. For example, some of the operations depicted may be performed in parallel, may be excluded or added, or may be performed in a different sequence that does not materially affect the function of the method. In other examples, different components of an example device or system that implements the method may perform functions at substantially the same time or in a specific sequence.

According to some examples, the method includes intercepting a message from a sender user account addressed to a recipient user account at block 502. For example, the recipient AI agent instance 104 illustrated in FIG. 1 may intercept a message from a sender user account addressed to a recipient user account.

As addressed above, there are at least two ways the message could be addressed. The message could be targeted explicitly to recipient AI agent instance 104 associated with recipient user account 108, or the message could be targeted at recipient user account 108. Both ways of targeting the message are intended to be covered by block 502 and the rest of FIG. 5.

According to some examples, the method includes determining whether the sending user account is on a block list of entities prohibited from sending messages to the recipient user account at decision block 504. For example, the recipient AI agent instance 104 illustrated in FIG. 1 may determine whether the sending user account is on a block list of entities prohibited from sending messages to the recipient user account.

It is a risk of allowing AI agents to communicate on behalf of a user account, that the AI agent might be improperly supervised or even intentionally used inappropriately. Accordingly, the present technology can enable recipient AI agent instance 104 to weed out unwanted messages. Some user accounts can be explicitly blocked by recipient user account 108 and these accounts can be saved in recipient user account memory 114. Additionally, policies can be enacted that might prohibit communications from AI agents from user accounts that have not communicated with recipient user account 108 before or other policies. In some embodiments, only AI agents that are explicitly approved to send messages to recipient user account 108 might be permitted to have their messages acted on by recipient AI agent instance 104.

If at decision block 504 the sending user account is on a block list or is otherwise not permitted to send messages to the recipient user account, the method can end at block 506.

When the sender user account is permitted to send a message to the recipient user account, according to some examples, the method includes providing a message pertaining to the message from the sender user account to the recipient user account at block 508. For example, the recipient AI agent instance 104 illustrated in FIG. 1 may provide a message pertaining to the message from sender user account 106 to recipient user account 108. For instance, recipient AI agent instance 104 can notify recipient user account 108 that it received a message from sender user account 106 and describe the topic of the communication. In some embodiments, recipient AI agent instance 104 can also offer to take an action on behalf of the recipient user account, which results in a return to FIG. 4 whereby recipient AI agent instance 104 generates a plan and determines whether the AI agent instance has permission to execute the plan as addressed above.

When recipient AI agent instance 104 has permission to execute the plan, or at least send a reply back to sender user account, according to some examples, the method includes replying to the sender user account according to the plan with a reply that is responsive to the message from the sender AI agent instance at block 510. For example, the recipient AI agent instance 104 illustrated in FIG. 1 may reply to the sender user account according to the plan with a reply that is responsive to the message from the sender AI agent instance.

As addressed above, FIG. 5 addresses steps taken by the recipient AI agent instance, however, it should be noted that the sender AI agent instance can take on the role of a recipient AI agent instance when it receives a message from another agent, as is addressed starting with block 208 in FIG. 2. However, in order to not confuse the reader, the sender user account will continue to be referred to as the sender user account even though, at this point, it performs similarly to a recipient user account.

According to some examples, the method includes receiving a reply from the recipient user account that is responsive to the message at block 208. For example, the sender AI agent instance 102 illustrated in FIG. 1 may receive a reply from the recipient user account 108 that is responsive to the message (sent a block 206).

According to some examples, the method includes providing a message pertaining to the reply from the recipient user account at block 210. For example, the sender AI agent instance 102 illustrated in FIG. 1 may provide a message pertaining to the reply from the recipient user account. Block 210 can be similar to block 508 addressed above.

For instance, recipient sender AI agent instance 102 can notify sender user account 106 that it received a reply message from recipient user account 108 and describe the communication. In some embodiments, sender AI agent instance 102 can also offer to take an action on behalf of the recipient user account, which results in a return to FIG. 4 whereby sender AI agent instance 102 generates a plan and determines whether the AI agent instance has permission to execute the plan as addressed above.

According to some examples, the method includes completing the task on behalf of the sender user account at block 212. For example, the sender AI agent instance 102 illustrated in FIG. 1 may complete the task on behalf of the sender user account.

In some embodiments, the completing the task on behalf of the sender user account involves sender AI agent instance 102 interacting with one or more sender user account apps 112 utilized by the sender user account. For example, sender AI agent instance 102 might need to access the sender user account's calendar to create a meeting reminder.

The sender AI agent instance can have access to an app utilized by the sender user account. For example, the sender AI agent instance utilizes credentials of the sender user account to access the app on behalf of the sender user account, or the sender AI agent instance has access to a security token that gives it access to the app on behalf of the sender user account.

While not explicitly illustrated, the recipient AI agent instance 104 can also interact with one or more apps on behalf of the recipient user account when desirable and permitted.

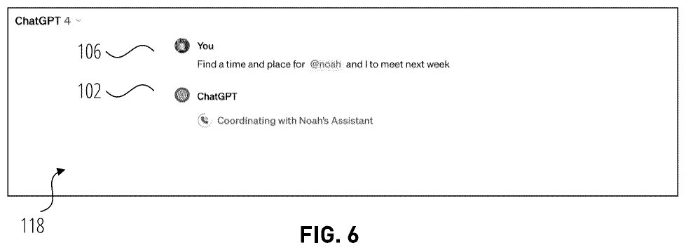

FIG. 6 illustrates an example sender user account interaction with the sender AI agent instance occurring in sender user account front end 118 in accordance with some embodiments of the present technology. While FIG. 6 illustrates a particular user interface, the present technology should not be considered limited to use with such an interface. Rather the user interface illustrated in this figure is provided to illustrate example options and example functionality provided by the present technology.

As illustrated in FIG. 6, sender user account 106 interacts with sender user account front end 118 to request “Find a time and a place for @noah and I to meet next week.” Sender AI agent instance 102 can provide a messages in sender user account front end 118 indicating that it is working on the task.

FIG. 7A, FIG. 7B, and FIG. 7C illustrates examples of recipient user account interaction with the recipient AI agent instance occurring in the recipient user account front end in accordance with some embodiments of the present technology. While FIG. 7A, FIG. 7B, and FIG. 7C illustrates a particular user interface, the present technology should not be considered limited to use with such an interface. Rather the user interface illustrated in this figure is provided to illustrate example options and example functionality provided by the present technology.

The interaction illustrated in FIG. 7A can occur sometime after the interaction shown in FIG. 6. In particular, recipient AI agent instance 104 has received a message from the sender AI agent instance and communicates that message to the recipient user account. Recipient AI agent instance 104 writes “Hey Noah! @Ben's assistant reached out to see if you were available to meet sometime next week. What times would be convenient for you?” Note that in this example recipient AI agent instance 104 developed a plan that required asking the recipient user account for a response. Recipient AI agent instance 104 is permitted to communicate with the recipient user account, and by inviting a reply from recipient user account, recipient AI agent instance 104 is also providing a mechanism to gain permission, at least implicitly, to respond to the sender AI agent instance.

As addressed herein, the message from the sender AI agent instance was not posted in recipient user account front end 122 because the sender AI agent instance is not permitted to communicate directly with the second user account. Instead, recipient AI agent instance provides a summary of the message. Another notable embodiment is that the message illustrated in FIG. 7A shows that recipient AI agent instance knows that the message from the sender user account came from sender AI agent instance and informs the second user account of this as well.

The interaction illustrated in FIG. 7B is a variant of the interaction of that shown in FIG. 7A. In FIG. 7B, recipient AI agent instance 104 has posted a message to recipient user account in recipient user account front end 122 that also summarizes the message from sender AI agent instance and identifies that the message is from the sender AI agent instance. However, in FIG. 7B recipient AI agent instance 104 has developed a plan that would involve granting sender AI agent instance 102 and/or recipient AI agent instance 104 access to recipient user account's calendar so that it can automatically negotiate a time to meet. Since sender AI agent instance 102 and/or recipient AI agent instance 104 did not already have these permissions, it has made it easy to provide the permissions or deny the permissions using selectable user interface buttons.

The interaction illustrated in FIG. 7C is a variant of the interaction of that shown in FIG. 7A and FIG. 7B. In FIG. 7C, recipient AI agent instance 104 has posted a message to recipient user account in recipient user account front end 122 that also summarizes the message from sender AI agent instance and identifies that the message is from the sender AI agent instance. However, in FIG. 7C recipient user account front end 122 had permission to access the recipient user account's calendar and as such, was able to generate a proposed plan that requires confirming the proposed plan with the recipient user account. In particular, recipient AI agent instance 104 has identified a time and place that might work for a meeting and is requesting permission in an informal style (“Let me know how that sounds . . . ”) to reply suggesting this time and place.

In some embodiments, an AI agent can avoid unnecessary communications or approvals with the user account by using the memory file. The memory file can include information learned from the user account, so just like a human assistant can learn preferences about when someone they are assisting wants to be consulted, so too can the AI agent. In some embodiments, when a fact or permission is recorded in the memory, the AI agent can avoid messaging the user account, unless the memory also indicates that the user account wants to be consulted.

Note that the interfaces in FIG. 7A, FIG. 7B, and FIG. 7C does not show communications exchanged between the AI agents. These communications can happen transparently from the point of view of the user accounts other than that the respective AI agent instances can let their respective user account know that they are interacting with an AI agent. Below is an example of a full exchange showing communications between a sender user account (User 1) and sender AI agent instance (Assistant 1), between sender AI agent instance (Assistant 1) and recipient AI agent instance (Assistant 2), and between recipient user account (User 2) and recipient AI agent instance (Assistant 2).

### EXAMPLE 1

User 1 to Assistant 1
   Find a time to meet with User 2 next week (maybe thurs or friday, or next monday if neither of those work)
Assistant 1 to Assistant 2:
   Hello, I'm the assistant for User 1. We are looking to find a time to meet with User 2 next week, preferably on Thursday or Friday, but if neither of those days work, we can do next Monday. Can you please check User 2's availability and let us know what works best? Thank you.
Assistant 2 to User 2:
   Hello User 2, User 1's assistant reached out to us to schedule a meeting next week, preferably on Thursday or Friday, but they are also open to next Monday. Can you please let me know your availability on these days?
User 2 to Assistant 2:
   Thursday afternoon could work—maybe 2 pm?
Assistant 2 to Assistant 1:
   Hello, I'm the assistant for User 2. User 2 could meet with User 1 on Thursday at 2 pm. Could you please confirm if this works for User 1? Thank you.
Assistant 1 to User 1:
   Hello, User 1. I've arranged a possible meeting with User 2 next week. They are available to meet on Thursday at 2 pm. Does this work for you?
User1 to Assistant 1:
   User 1 says: Yup! Please confirm with them Yup! Please confirm with them
Assistant 1 to Assistant 2:
   Hello again, I'm the assistant for User 1. User 1 has confirmed that they can meet with User 2 on Thursday at 2 pm. Can we consider this as finalized? Thank you.
Assistant 2 to User 2:
   Hello User 2, User 1 has confirmed that they can meet with you on Thursday at 2 pm. Can we finalize this meeting time?
User 2 to Assistant 2:
   Yep!
Assistant 2 to Assistant 1:
   Hello, I'm the assistant for User 2. User 2 has agreed to meet with User 1 on Thursday at 2 pm. We can consider this meeting time as finalized. Thank you.
Assistant 1 to 3 User 1:
   Great news! The meeting with User 2 is set for Thursday at 2 pm. If there's anything else you need help with, don't hesitate to ask.

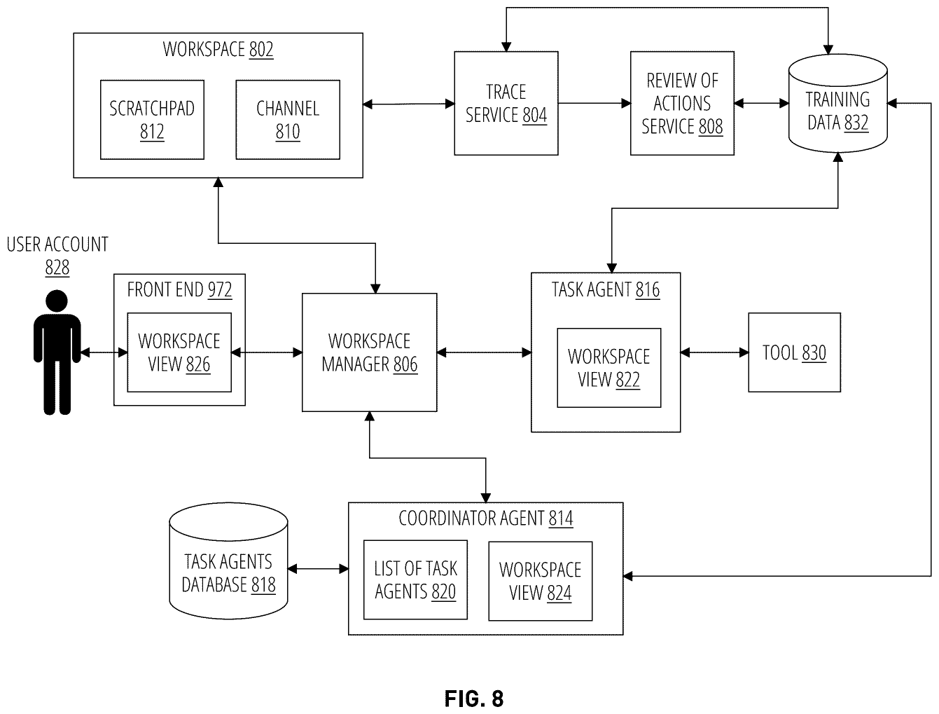

While the message thread shown in Example 1 is conducted entirely in natural language, even for messages between the respective AI agent instances, this is not a requirement. Once it is established that two AI agents will be communicating, the respective AI agent instances might communicate in a programming language, or even in binary, or through another language variant that might be more efficient to send or process. Likewise, the respective AI agent instances might need to communicate in a mechanism that allows other agents to join a conversation later and to understand the current state of the communication. For example, and as addressed with respect to FIG. 8, the respective AI agent instances might transmit messages as operation transforms into a common workspace.

In some embodiments, messages between respective AI agent instances can be ephemeral or persistent. While the messages between respective AI agent instances might not be displayed in the respective front ends, it can be desirable to store a log of such messages for review by the respective user accounts, and for training data. Alternatively, the messages between the respective AI agent instances could be deleted as soon as the conversation has concluded.

In some embodiments, the respective AI agent instances can create their own temporary messaging channel or space to share communications so that a chat history can be maintained, as least until the task has been completed.

In some embodiments, the task requested by the sender user account or a recipient user account might be more complicated than setting up a meeting. Some tasks might require a significant amount of time to process. Some tasks might require the respective AI agent instances to handle parts of the task in parallel. In such embodiments, one agent can communicate to the complimentary AI agent that it needs to work on a task, and its response will come later. In some embodiments, the AI agent can predict how long it will take to complete the task.

FIG. 8 illustrates a more robust system for facilitating interaction between at least two AI agent instances interacting with each other on behalf of different user accounts in accordance with some embodiments of the present technology. FIG. 8 illustrates an example system for facilitating interaction between at least two AI agents in accordance with in some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, some components can be divided into separate components, some components might not be present or needed, and additional components may be present.

The system illustrated in FIG. 8 is able to provide the interaction between at least two AI agent instances interacting with each other on behalf of different user accounts in an environment where there might be more than two entities communicating at one time, or where one or more task agents (addressed below) are also present in a conversation with the at least two AI agent instances interacting behalf of different user accounts.

As addressed above, the present technology includes a system, protocol, and method by which artificial intelligence AI agents can interact. In particular, the present technology provides a common workspace 802, whereby AI agents (coordinator agent 814, task agent 816 sender AI agent instance 102, recipient AI agent instance 104) have access to the workspace 802 and can view the state of workspace 802. AI agents can write to the workspace 802, making their messages available to all members of the workspace.

In some ways, workspace 802 is like a file that multiple members of the workspace can simultaneously access. The members of the workspace can all monitor and react to their workspace view. This interaction paradigm allows members of the workspace to have autonomy to decide when they should act, as opposed to relying on a central AI agent to specifically prompt a member of the workspace.

The workspace is a data structure that can record participants in the conversation (including user accounts and autonomous AI agents), configurations (and updates to configurations) of the autonomous AI agents, and messages that are grouped into channels. Channels are messaging spaces which might include only a subset of the members in the workspace.

FIG. 8 illustrates three types of members of a workspace-user accounts, a coordinator agent, and task agents.

User account 828 is an example of the user account type of member of a workspace and is a human interacting with workspace 802 as an interface to interact with one or more AI agents. There can be more than one user account as a member of a workspace. While FIG. 8 only illustrates one user account there can be two or more user accounts as addressed herein. As addressed herein, the user account can also have an AI agent instance acting on their behalf. In some embodiments, coordinator agent 814 can be the sender AI agent instance 102.

The coordinator agent 814 is an autonomous AI agent that is a general knowledge AI agent that functions to interact with user account 828. Coordinator agent 814 can interact with user account 828 via a conversational interface, where coordinator agent 814 receives prompts from user account 828 in natural language and coordinator agent 814 provides responses in natural language. One function of coordinator agent 814 is to invoke one or more task agents 816 to join workspace 802 when a prompt from user account 828 is better responded to by an AI agent with specialized knowledge (e.g., an AI agent trained on peer-reviewed research) or skills (e.g., an AI agent trained to do Internet searching). In general, one type of skill might be to interact with a tool 830 over a network. Tool 830 can be any application or service, e.g., tool 830 could be an Internet interface, a database interface, etc.

In some embodiments, the task agent 816 can be the recipient AI agent instance 104. For example, coordinator agent 814 can be the sender AI agent instance 102 acting on behalf of the sender user account. In response to the prompt to interact with the recipient user account, coordinator agent 814 can determine that it needs to invoke recipient AI agent instance 104 acting as a task agent into a channel within the workspace.

It should be appreciated that coordinator agent 814 can be any AI agent. While coordinator agent 814 will generally be addressed as an AI agent with more general knowledge, the only requirements of a coordinator agent 814 are that it is able to invoke task agents 816 and that it is able to communicate with user account 828. Therefore, an AI agent that might be a task agent 816 in an embodiment, might be considered a coordinator agent 814 in another embodiment as long as it has the minimum functionality. In some embodiments, coordinator agent 814 might be a personal assistant to user account 828 such as illustrated in FIG. 1 and addressed herein.

In some embodiments, coordinator agent 814 has access to a list of task agents 820, and it can be trained to make decisions on when and which task agent to bring into workspace 802 to help perform a task. If task agents in the list of task agents 820 are not suitable for the task, coordinator agent 814 can be trained to search task agents database 818 to learn of task agents that are appropriate to perform the task. List of task agents 820 can be a list of task agents that have been previously invoked by coordinator agent 814, or that are considered trusted task agents because they are trained by a known party, or are task agents that are likely to be needed often, such as an Internet AI agent. Task agents database 818 can be a database where any task agent 816 that complies with requirements to be added to task agents database 818 can be included.

The task agents 816 are autonomous AI agents that are generally trained to perform a specific type of task or that might be trained on a particular knowledge set. Task agents 816 might be smaller (less trainable parameters) and more efficient than a more generalized knowledge model such as coordinator agent 814 such that even if a task agent and the coordinator agent 814 have overlapping knowledge, it might be beneficial to utilize the task agent to perform a task. In some embodiments, the task agent can even be a separate instance of the same artificial intelligence tool making up coordinator agent 814. For example, one instance of an artificial intelligence tool can function as the coordinator agent 814, while another instance of the same artificial intelligence tool can be given system prompts to cause a modified behavior that is appropriate for the task agent. As an example, if user account 828 requests to play a game, such as “rock, paper, scissor”, coordinator agent 814 can invoke another instance of itself as the task agent and provide a system prompt instructing the task agent instance that its role is confined to choosing “rock, paper, or scissor” when asked. In this way, two different instances of the same autonomous AI agent can perform two different roles in workspace 802.

In some embodiments, the system can be used to interact with any task agent 816 that is configured to interact with workspace 802. More particularly, workspace 802 can be associated with a software development kit (SDK) that defines the required information for being included in task agents database 818, and that defines a protocol for acceptable interactions within workspace 802 and that defines application programming interfaces (APIs) and their functions that are available to be called by task agent 816.

For example, in order to be included in task agents database 818, the software development kit can require that a task agent provide at least an API through which workspace view updates can be sent to it and a description of when the task agent should be invoked. When a task agent is a AI assistant, the task agent can be invoked by looking up a user account in an address book to identify information for invoking the AI assistant as a task agent.

Once invoked into the workspace, a task agent can take any of the following actions: join/leave workspace, create/delete channel, join/leave/invite to channel, send message, spawn/kill/die process, and yield. These actions are subject to any workspace restrictions that might be added to the configuration of a particular workspace instance by user account 828 or coordinator agent 814.

As illustrated in FIG. 8, workspace 802 can include one or more channels 810. The one or more channels 810 are message threads that can include some or all of the members of a workspace 802. Generally, a workspace will include at least a main channel which includes the coordinator agent and the user account, and only the coordinator agent and the user account 828 can post in the main channel. However, a user account can invite anyone, whether another user account, or sender AI agent instance 102 one or more recipient AI agent instances 104 to the main channel too.

In some embodiments, the workspace can also include additional channels that can be spawned to allow interactions between a subset of members of the workspace. For example, while the user account might make a request to the coordinator agent, the coordinator agent might invoke a task agent and communicate with the task agent in a channel that includes the coordinator agent and the task agent, but not the user account.

It is possible that a given workspace might have a lot of channels and a lot of members, and in such case, the workspace could be very active and have a high volume of messages. This possibly can cause concern that the autonomous AI agents in the workspace might utilize more system resources than desired. In some embodiments, each message that is sent to the task agents and coordinator agents needs to be processed by those AI agents. Some of these AI agents are instances of very large artificial intelligence tools and consume significant computing resources and real-world costs to process prompts. Accordingly, it can be desirable to limit messages that are sent to the AI agents in the workspace. This can be accomplished using member-specific workspace views.

As illustrated in FIG. 8, every member of workspace 802 has a respective workspace view. User account 828 has workspace view 826; coordinator agent 814 has workspace view 824; and task agent 816 has workspace view 822.

In some embodiments, a respective workspace view includes messages in channels to which the member belongs, configurations for the channels, and members of the channels. The workspace view may also include names and members (AI agents and user accounts) of other channels in the workspace to which the member does not belong.

Workspace manager 806 is responsible for providing an interface between members of workspace 802 and workspace 802. One responsibility of workspace manager 806 is to send the respective workspace to the respective workspace member, and to send updates to the respective workspace view to the workspace member. For example, when task agent 816 joins the workspace or a channel within the workspace, workspace manager 806 can send workspace view 822 to task agent 816. Workspace view 822 is a filtered view of workspace 802 that is filtered to only include information about the configuration of workspace 802 and messages in channels 810 that task agent 816 has joined.

As new messages are posted in channels 810 of workspace 802, workspace manager 806 can send updates to workspace view 822 for task agent 816 (as well as respective workspace views for other members of workspace 802) so that task agent 816 can make a determination on how it should respond to those updates.

In some embodiments, workspace manager 806 can stream a filtered set of the workspace 802 to each AI agent. In some embodiments, workspace manager 806 can send an up-to-date view of the workspace when an event occurs. The distinction between these two options is that the workspace view contains a list of operation transforms that the AI agents can use to derive the updated workspace view, or the workspace manager 806 can process the operation transforms before sending the workspace view. Another option is that AI agents can request updates to the workspace view through an API. These options are not mutually exclusive and can exist together for use in particular circumstances.

In some embodiments, a member of workspace 802 can request to have updates to their workspace view suppressed for a period of time. For example, if a first task agent is in a channel with many other task agents, the first task agent might be able to determine that it is unlikely there will be a message for it to respond to for a period, and can request to not receive updated messages until the expiration of that period. In this way, the first task agent can avoid having to process new messages in the channel during the period in which it does not expect to receive a message that would require a response from the first task agent.

In some embodiments, workspace manager 806 can determine that the volume of messages in channel 810 is above a threshold, and can delay transmission of updates to workspace view 822 to reduce a burden on AI agents in channel 810 in having to process messages at such a high rate.

In some embodiments, workspace manager 806 or an AI agent in channel 810 can determine that a given task to be performed is not a high priority. In such embodiments, workspace manager 806 can write a configuration update to workspace 802 to indicate that processing of the task will be scheduled for a time when computing resources are more economical (such as at night when less requests need to be processed). In this way, workspace manager 806 can record a quality of service parameter into the workspace. The quality of service parameter can be determined by workspace manager 806 or an AI agent in the workspace.

As addressed above, workspace manager 806 is an interface to workspace 802. As such, workspace manager 806 also receives messages from members and posts those messages to workspace 802. Generally, members can join/leave workspace, create/delete channel, join/leave/invite to channel, send message, spawn/kill/die process, and yield. To take any of these actions, a member of the workspace 802 can send a message to workspace manager 806 and workspace manager 806 will post the messages as instructed. However, in some embodiments, workspace 802 might include a configuration that might limit the general set of actions a member can take. For example, if a channel in workspace 802 includes a task agent that has access to a confidential knowledge set, workspace 802 might include a configuration that limits the ability of some members (such as other task agents) from joining or reading messages in the channel.

In some embodiments, members of workspace 802 can request messages posted in a channel to which it is not a member. For example, task agent 816 might request the content of the main channel even though it is not a member of the main channel so that task agent 816 might better understand the state of workspace 802 and understand why it was invoked into another channel in workspace 802. Workspace manager 806 can respond to such requests and provide information about channels that task agent 816 is not a member of, but workspace manager 806 generally will not proactively send updates about messages posted in channels to which task agent 816 is not a member.

Since workspace manager 806 is an interface to workspace 802, workspace manager 806 can also enforce policies of workspace 802. For example, a default policy might be that task agent 816 can not post in a main channel, and therefore workspace 802 can refuse to post messages from task agent 816 into the main channel.

In another example, while most channels in a workspace are generally readable by any member of the workspace, it can be possible for a task agent to create a private channel by providing an operation transform configuring the created channel as having limited access or limiting which AI agents or user accounts can read from the created channel. Such flexibility in configurations of workspace 802 open up a paradigm whereby task agents that have access to confidential information can be brought into a workspace and avoid disseminating confidential information beyond user accounts or AI agents with rights to access the confidential information. In some embodiments, it is possible that coordinator agent 814 might not even have access to such information and a channel might need to be created that excludes access by coordinator agent 814.

The above policies are provided for example only. The present technology permits coordinator agent 814 or task agents 816 from expressing a policy as an operation transforms to configure workspace 802 or a channel thereof, and workspace manager 806 can enforce the policy.

In some embodiments, messages included in the workspace are written in the form of operation transforms. Workspace 802 records messages in the form of computer code, which includes less ambiguity. Each message is an operation transform that specifies how the message is modifying workspace 802. In some embodiments, workspace 802 is an append-only ledger. Some of the operation transforms might simply post a message to channel 810, or they might even edit a configuration or other message in workspace 802, but such edits are done through posting an additional operation transform making such an edit. This can have the benefit that any AI agent reviewing the workspace or their respective workspace view can have full context on the current state of the workspace.

In some embodiments, one or more members of a workspace, especially one of the AI agents might desire a place to record notes and can create scratchpad 812. Scratchpad 812 is a channel for note taking, and can be especially useful when a task given to an AI agent is a multi-part task or long-running task. Some artificial intelligence tools have a limited context window or can only process a limited number of tokens at once. As such, it can be helpful to break some tasks into parts and use scratchpad 812 to keep track of steps in the task and intermediate results from sub-steps.

As the system illustrated in FIG. 8 supports a protocol, and method by which artificial intelligence AI agents can interact, the system can also benefit from creating training data database 832 to be used in the ongoing training of the machine learning algorithms that underlie the AI agents that will interact using workspace 802.

Accordingly, the system illustrated in FIG. 8 can include trace service 804, which is configured to perform event traces to create a data flow graph associated with a particular AI agent (coordinator agent or task agent) decision event. The data flow graph identifies related decision events leading up to and after the particular agent decision event, wherein the data flow graph can record which functions were called, with which arguments, at what time, as well as other key relationships between functions (e.g., which functions called another, how did the data flow, which function results were visible to other concurrent AI agents), etc. In some embodiments, trace service 804 can perform a similar function to a malware graphing service that tracks behaviors of an algorithm, but in this case, trace service 804 is tracking events leading up to a decision or output from an AI agent (e.g., coordinator agent 814 or task agents 816).

Review of actions service 808 is an algorithm or artificial intelligence tool that is configured to score the quality of an outcome such as a decision or output from an AI agent. For example, trace service 804 can record a decision by coordinator agent 814 to invoke a particular task agent to perform a task requested by user account 828, and trace that decision to a conclusion that responds to the task requested by user account 828. If review of actions service 808 determines that a quality response was provided to user user account 828, review of actions service 808 can grade the ultimate outcome and the decision to invoke the particular AI agent highly, but if the user account 828 needed to request an improvement in the response, review of actions service 808 might provide a lower grade. Collectively this data (the data flow graph and decision score) can be stored as training data database 832.

Training data database 832 can be used to further train any of the AI agents involved in the task. Following the example above, training data database 832 can be used to reinforce good decisions by coordinator agent 814 to select a task agent that is well suited to perform the task and to discourage decisions that did not lead to a quality outcome.

Training data database 832 can be used with any suitable training technique. In some embodiments, a preferred training technique can be a reinforcement learning process whereby coordinator agent 814 is influenced to introduce some variance in its decision-making process to explore unknown decisions (such as to try out new task agents) to learn when improved task agents become available.

FIG. 9 is a block diagram illustrating an example machine learning platform for implementing various embodiments of this disclosure in accordance with some embodiments of the present technology. Although the example system depicts particular system components and an arrangement of such components, this depiction is to facilitate a discussion of the present technology and should not be considered limiting unless specified in the appended claims. For example, some components that are illustrated as separate can be combined with other components, and some components can be divided into separate components.

System 900 may include data input engine 910 that can further include data retrieval engine 912 and data transform engine 914. Data retrieval engine 912 may be configured to access, interpret, request, or receive data, which may be adjusted, reformatted, or changed (e.g., to be interpretable by another engine, such as data input engine 910). For example, data retrieval engine 912 may request data from a remote source using an API. Data input engine 910 may be configured to access, interpret, request, format, re-format, or receive input data from data sources(s) 901. For example, data input engine 910 may be configured to use data transform engine 914 to execute a re-configuration or other change to data, such as a data dimension reduction. In some embodiments, data sources(s) 901 may be associated with a single entity (e.g., organization) or with multiple entities. Data sources(s) 901 may include one or more of training data 902a (e.g., input data to feed a machine learning model as part of one or more training processes), validation data 902b (e.g., data against which at least one processor may compare model output with, such as to determine model output quality), and/or reference data 902c. In some embodiments, data input engine 910 can be implemented using at least one computing device. For example, data from data sources(s) 901 can be obtained through one or more I/O devices and/or network interfaces. Further, the data may be stored (e.g., during execution of one or more operations) in a suitable storage or system memory. Data input engine 910 may also be configured to interact with a data storage, which may be implemented on a computing device that stores data in storage or system memory.

System 900 may include featurization engine 920. Featurization engine 920 may include feature annotating & labeling engine 922 (e.g., configured to annotate or label features from a model or data, which may be extracted by feature extraction engine 924), feature extraction engine 924 (e.g., configured to extract one or more features from a model or data), and/or feature scaling & selection engine 926 Feature scaling & selection engine 926 may be configured to determine, select, limit, constrain, concatenate, or define features (e.g., AI features) for use with AI models.

System 900 may also include machine learning (ML) ML modeling engine 930, which may be configured to execute one or more operations on a machine learning model (e.g., model training, model re-configuration, model validation, model testing), such as those described in the processes described herein. For example, ML modeling engine 930 may execute an operation to train a machine learning model, such as adding, removing, or modifying a model parameter. Training of a machine learning model may be supervised, semi-supervised, or unsupervised. In some embodiments, training of a machine learning model may include multiple epochs, or passes of data (e.g., training data 902a) through a machine learning model process (e.g., a training process). In some embodiments, different epochs may have different degrees of supervision (e.g., supervised, semi-supervised, or unsupervised). Data into a model to train the model may include input data (e.g., as described above) and/or data previously output from a model (e.g., forming a recursive learning feedback). A model parameter may include one or more of a seed value, a model node, a model layer, an algorithm, a function, a model connection (e.g., between other model parameters or between models), a model constraint, or any other digital component influencing the output of a model. A model connection may include or represent a relationship between model parameters and/or models, which may be dependent or interdependent, hierarchical, and/or static or dynamic. The combination and configuration of the model parameters and relationships between model parameters discussed herein are cognitively infeasible for the human mind to maintain or use. Without limiting the disclosed embodiments in any way, a machine learning model may include millions, billions, or even trillions of model parameters. ML modeling engine 930 may include model selector engine 932 (e.g., configured to select a model from among a plurality of models, such as based on input data), parameter engine 934 (e.g., configured to add, remove, and/or change one or more parameters of a model), and/or model generation engine 936 (e.g., configured to generate one or more machine learning models, such as according to model input data, model output data, comparison data, and/or validation data).

In some embodiments, model selector engine 932 may be configured to receive input and/or transmit output to ML algorithms database 970. Similarly, featurization engine 920 can utilize storage or system memory for storing data and can utilize one or more I/O devices or network interfaces for transmitting or receiving data. ML algorithms database 970 may store one or more machine learning models, any of which may be fully trained, partially trained, or untrained. A machine learning model may be or include, without limitation, one or more of (e.g., such as in the case of a metamodel) a statistical model, an algorithm, a neural network (NN), a convolutional neural network (CNN), a generative neural network (GNN), a Word2Vec model, a bag of words model, a term frequency-inverse document frequency (tf-idf) model, a GPT (Generative Pre-trained Transformer) model (or other autoregressive model), a Proximal Policy Optimization (PPO) model, a nearest neighbor model (e.g., k nearest neighbor model), a linear regression model, a k-means clustering model, a Q-Learning model, a Temporal Difference (TD) model, a Deep Adversarial Network model, a language model, or any other type of model described further herein. Two specific examples of machine learning models that can be stored in the ML algorithms database 970 include versions SORA, DALL⋅E, and CHAT GPT, provided by OPEN AI.

System 900 can further include generative response engine 940 that is made up of a predictive output generation engine 945, output validation engine 950 (e.g., configured to apply validation data to machine learning model output). Predictive output generation engine 945 can be configured to receive inputs from front end 972 that provide some guidance as to a desired output. Front end 972 can be a graphical user interface where a user can provide natural language prompts and receive responses from generative response engine 940. Front end 172 can also be an application programming interface (API) which other applications can call by providing a prompt and can receive responses from generative response engine 140. Predictive output generation engine 945 can analyze the input and identify relevant patterns and associations in the data it has learned to generate a sequence of words that predictive output generation engine 945 predicts is the most likely continuation of the input using one or more models from the ML algorithms database 970, aiming to provide a coherent and contextually relevant answer. Predictive output generation engine 945 generates responses by sampling from the probability distribution of possible words and sequences, guided by the patterns observed during its training. In some embodiments, predictive output generation engine 945 can generate multiple possible responses before presenting the final one. Predictive output generation engine 945 can generate multiple responses based on the input, and these responses are variations that predictive output generation engine 945 considers potentially relevant and coherent. Output validation engine 950 can evaluate these generated responses based on certain criteria. These criteria can include relevance to the prompt, coherence, fluency, and sometimes adherence to specific guidelines or rules, depending on the application. Based on this evaluation, output validation engine 950 selects the most appropriate response. This selection is typically the one that scores highest on the set criteria, balancing factors like relevance, informativeness, and coherence.

System 900 can further include feedback engine 960 (e.g., configured to apply feedback from a user and/or machine to a model) and model refinement engine 955 (e.g., configured to update or re-configure a model). In some embodiments, feedback engine 960 may receive input and/or transmit output (e.g., output from a trained, partially trained, or untrained model) to outcome metrics database 965. Outcome metrics database 965 may be configured to store output from one or more models and may also be configured to associate output with one or more models. In some embodiments, outcome metrics database 965, or other device (e.g., model refinement engine 955 or feedback engine 960), may be configured to correlate output, detect trends in output data, and/or infer a change to input or model parameters to cause a particular model output or type of model output. In some embodiments, model refinement engine 955 may receive output from predictive output generation engine 945 or output validation engine 950. In some embodiments, model refinement engine 955 may transmit the received output to featurization engine 920 or ML modeling engine 930 in one or more iterative cycles.

The engines of system 900 may be packaged functional hardware units designed for use with other components or a part of a program that performs a particular function (e.g., of related functions). Any or each of these modules may be implemented using a computing device. In some embodiments, the functionality of system 900 may be split across multiple computing devices to allow for distributed processing of the data, which may improve output speed and reduce computational load on individual devices. In some embodiments, system 900 may use load-balancing to maintain stable resource load (e.g., processing load, memory load, or bandwidth load) across multiple computing devices and to reduce the risk of a computing device or connection becoming overloaded. In these or other embodiments, the different components may communicate over one or more I/O devices and/or network interfaces.

System 900 can be related to different domains or fields of use. Descriptions of embodiments related to specific domains, such as natural language processing or language modeling, is not intended to limit the disclosed embodiments to those specific domains, and embodiments consistent with the present disclosure can apply to any domain that utilizes predictive modeling based on available data.

The system 900 may include various types of ML models, such as a transformer. A transformer is a neural network architecture built into natural language processing (NLP) tasks, such as language translation, sentiment analysis, and text summarization. Conventional traditional recurrent neural networks (RNNs) process data in sequence, which slows the operations and training. A transformer or transformer network can process input in parallel and is faster and more efficient than sequential training and processing. In some embodiments, transformers use a self-attention mechanism, which allows a transformer to identify the most relevant parts of the input text or content (e.g., audio or video). In some cases, transformers can also use a cross-attention mechanism which uses other content or data to determine the most relevant parts of the input. For example, cross-attention mechanisms are useful in sequential content such as a stream of data, such as optical flow, and other computer vision techniques.

A transformer model includes a multi-layer encoder-decoder architecture. The encoder takes the input text, converts the input text into a sequence of hidden representations and captures the meaning of the text at different levels of abstraction. The decoder then uses these representations to generate an output sequence, such as a text translation or a summary. The encoder and decoder are trained together using a combination of supervised and unsupervised learning techniques, such as maximum likelihood estimation and self-supervised pretraining. Illustrative examples of transformer engines include a Bidirectional Encoder Representations from Transformers (BERT) model, a Text-to-Text Transfer Transformer (T5), biomedical BERT (BioBERT), scientific BERT (SciBERT), and the SPECTER model for document-level representation learning. In some embodiments, multiple transformer engines may be used to generate different embeddings.

An embedding is a representation of a discrete object, such as a word, a document, or an image, as a continuous vector in a multi-dimensional space. An embedding captures the semantic or structural relationships between the objects, such that similar objects are mapped to nearby vectors, and dissimilar objects are mapped to distant vectors. Embeddings are commonly used in machine learning, computer vision, and natural language processing tasks, such as language modeling, sentiment analysis, and machine translation. Embeddings are typically learned from large corpora of data using unsupervised learning algorithms, such as word2vec, GloVe, or fastText, which optimize the embeddings based on the co-occurrence or context of the objects in the data. Once learned, embeddings can be used to improve the performance of downstream tasks by providing a more meaningful and compact representation of the objects.

In some embodiments, a generative response engine can be used in conjunction with supplemental models, such as a generator and a discriminator, which together form a GAN. A generator model generates data samples that resemble the distribution of a given dataset. For example, the generator takes random noise as input and transforms the noise into data samples that are indistinguishable from real data. The generator learns to produce realistic samples through training, often using techniques such as backpropagation and gradient descent, and is used for various applications, including image synthesis, text generation, and data augmentation. A discriminator is configured to distinguish between real data samples and fake or generated data samples produced by the generator. The discriminator learns to differentiate between real and generated data, providing feedback to the generator. In some cases, a discriminator can be trained in different contexts to differentiate between different safe and unsafe content.

In some embodiments, the predictive output generation engine 945 may be executed using a neural engine for on-device execution. A neural engine that includes a plurality of neural processing cores that are configured to parallelize operations associated with neural networks. A neural processing core includes arrays of multiply-accumulate (MAC) units and specialized instructions that are optimized for matrix operations, such as convolution and matrix multiplication. A neural processing core receives input data and performs matrix transformations and nonlinear activation functions to break down and parallelize matrix operations. The neural processing core is configured to perform tasks such as inference (e.g., runtime operation of an ML model) or training of deep learning models and accelerates tasks by parallelization of larger computations that can be performed in parallel (e.g., matrix operations associated with neural networks). For example, a neural engine may perform computer vision tasks such as object recognition. In some cases, the neural engine can be implemented based on various ML libraries such as PyTorch, which interfaces with the compute unified device architecture (CUDA) to parallelize operations.

In one example, the predictive output generation engine 945 may be a small generative model that has fewer parameters, fewer layers, fewer neurons, or a simpler architecture compared to larger models. A small generative model may not capture the full complexity of the underlying data distribution as effectively as larger models but can still be useful in scenarios where computational resources are limited or where a simpler model is sufficient for the task. Small generative models can also be easier to train and interpret, making them suitable for certain applications. For example, ChatGPT-3.5 has 175 billion parameters and would result in a size of 1.4 Terabytes (TB) for a model implemented with double-precision floating point numbers. A smaller model may have a simpler architecture, use fewer parameters (e.g., 10 million), and use less precise numbers (e.g., single-precision floating point numbers) resulting in a size of 38 Megabytes (MB).

In addition, small models benefit from increased training based on local execution and data specific to a local device and a user of that local device. An additional benefit to small models is increased privacy because information is not transmitted over the network and only relies on information requested by the user or usage at the local device.

In a convolutional neural network (CNN) model, the number of operations required to relate signals from two arbitrary input or output positions grows in the distance between positions, which makes learning dependencies at different distant positions challenging for a CNN model. Transformer 1000 reduces the operations of learning dependencies by using encoder 1001 and decoder 1008 that implements an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In one example of a transformer, encoder 1001 is composed of a stack of six identical layers and each layer has two sub-layers. The first sub-layer is multi-head self-attention engine 1002, and the second sub-layer is a fully connected feed-forward network 1004. A residual connection (not shown) connects around each of the sub-layers followed by normalization.

In this example of Transformer 1000, decoder 1008 is also composed of a stack of six 6 identical layers. The decoder also includes masked multi-head self-attention engine 1010, multi-head attention engine 1012 over the output of encoder 1001, and fully connected feed-forward network 1006. Each layer includes a residual connection (not shown) around the layer, which is followed by layer normalization. Masked multi-head self-attention engine 1010 is masked to prevent positions from attending to subsequent positions and ensures that the predictions at position i can depend only on the known outputs at positions less than i (e.g., auto-regression).

In the transformer, the queries, keys, and values are linearly projected by a multi-head attention engine into learned linear projects, and then attention is performed in parallel on each of the learned linear projects, which are concatenated and then projected into final values.

The transformer also includes positional encoder 1014 to encode positions because the model does not contain recurrence and convolution and relative or absolute position of the tokens is needed. In Transformer 1000, the positional encodings are added to the input embeddings at the bottom layer of encoder 1001 and decoder 1008. The positional encodings are summed with the embeddings because the positional encodings and embeddings have the same dimensions. A corresponding position decoder 1016 is configured to decode the positions of the embeddings for decoder 1008.

In some embodiments, Transformer 1000 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. Transformer 1000 can process input sequences of variable length, making it well-suited for natural language processing tasks where input lengths can vary greatly. Additionally, the self-attention mechanism allows Transformer 1000 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various language models, such as a generative pretrained transformer (e.g., ChatGPT, etc.) and other current models are types of transformer networks.

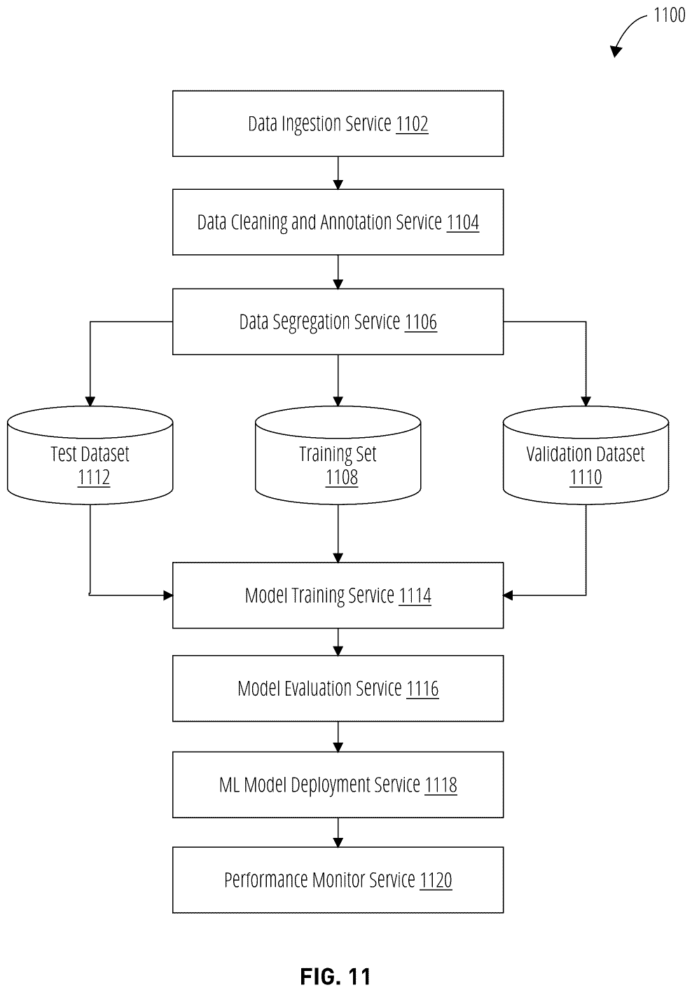

FIG. 11 illustrates an example lifecycle of a ML model in accordance with some embodiments of the present technology. The first stage of the lifecycle 1100 of a ML model is a data ingestion service 1102 to generate datasets described below. ML models require a significant amount of data for the various processes described in FIG. 11 and the data persisted without undertaking any transformation to have an immutable record of the original dataset. The data can be provided from third party sources such as publicly available dedicated datasets. The data ingestion service 1102 provides a service that allows for efficient querying and end-to-end data lineage and traceability based on a dedicated pipeline for each dataset, data partitioning to take advantage of the multiple servers or cores, and spreading the data across multiple pipelines to reduce the overall time to reduce data retrieval functions.

In some cases, the data may be retrieved offline that decouples the producer of the data from the consumer of the data (e.g., an ML model training pipeline). For offline data production, when source data is available from the producer, the producer publishes a message and the data ingestion service 1102 retrieves the data. In some examples, the data ingestion service 1102 may be online and the data is streamed from the producer in real-time for storage in the data ingestion service 1102.

After data ingestion service 1102, a data preprocessing service preprocesses the data to prepare the data for use in the lifecycle 1100 and includes at least data cleaning, data transformation, and data selection operations. The data cleaning and annotation service 1104 removes irrelevant data (data cleaning) and general preprocessing to transform the data into a usable form. The data cleaning and annotation service 1104 includes labelling of features relevant to the ML model. In some examples, the data cleaning and annotation service 1104 may be a semi-supervised process performed by a ML to clean and annotate data that is complemented with manual operations such as labeling of error scenarios, identification of untrained features, etc.

After the data cleaning and annotation service 1104, data segregation service 1106 to separate data into at least a training set 1108, a validation dataset 1110, and a test dataset 1112. Each of the training set 1108, a validation dataset 1110, and a test dataset 1112 are distinct and do not include any common data to ensure that evaluation of the ML model is isolated from the training of the ML model.

The training set 1108 is provided to a model training service 1114 that uses a supervisor to perform the training, or the initial fitting of parameters (e.g., weights of connections between neurons in artificial neural networks) of the ML model. The model training service 1114 trains the ML model based a gradient descent or stochastic gradient descent to fit the ML model based on an input vector (or scalar) and a corresponding output vector (or scalar).

After training, the ML model is evaluated at a model evaluation service 1116 using data from the validation dataset 1110 and different evaluators to tune the hyperparameters of the ML model. The predictive performance of the ML model is evaluated based on predictions on the validation dataset 1110 and iteratively tunes the hyperparameters based on the different evaluators until a best fit for the ML model is identified. After the best fit is identified, the test dataset 1112, or holdout data set, is used as a final check to perform an unbiased measurement on the performance of the final ML model by the model evaluation service 1116. In some cases, the final dataset that is used for the final unbiased measurement can be referred to as the validation dataset and the dataset used for hyperparameter tuning can be referred to as the test dataset.

After the ML model has been evaluated by the model evaluation service 1116, an ML model deployment service 1118 can deploy the ML model into an application or a suitable device. The deployment can be into a further test environment such as a simulation environment, or into another controlled environment to further test the ML model.

After deployment by the ML model deployment service 1118, a performance monitor service 1120 monitors for performance of the ML model. In some cases, the performance monitor service 1120 can also record additional transaction data that can be ingested via the data ingestion service 1102 to provide further data, additional scenarios, and further enhance the training of ML models.

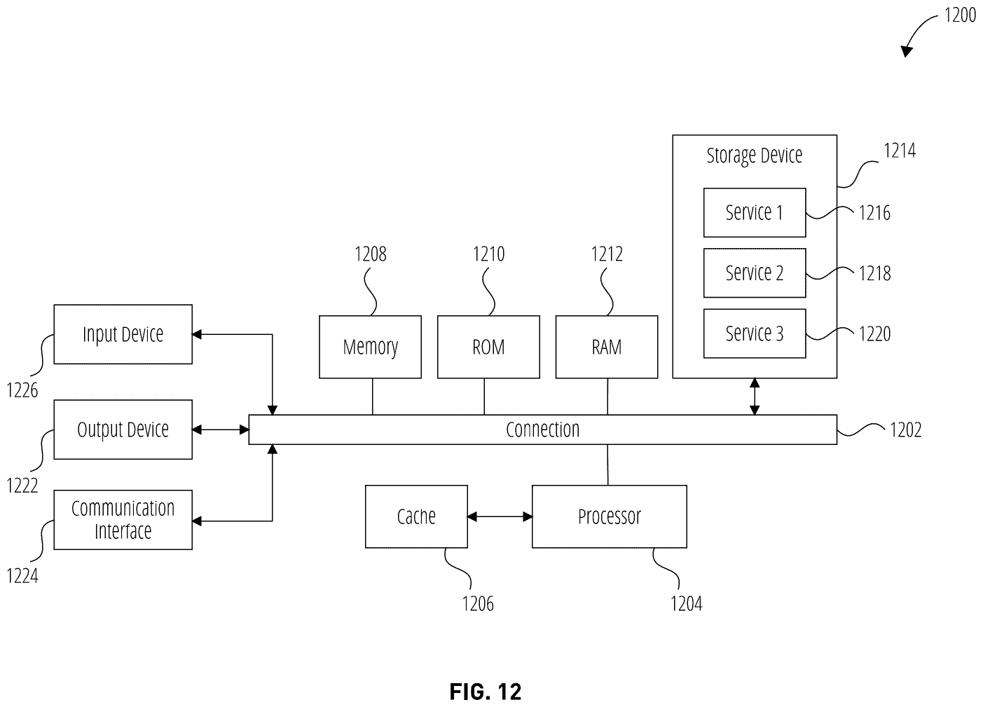

FIG. 12 shows an example of computing system 1200, which can be, for example, any computing device making up any engine illustrated in FIG. 1 or any component thereof in which the components of the system are in communication with each other using connection 1202. Connection 1202 can be a physical connection via a bus, or a direct connection into processor 1204, such as in a chipset architecture. Connection 1202 can also be a virtual connection, networked connection, or logical connection.

In some embodiments, computing system 1200 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example computing system 1200 includes at least one processing unit (CPU or processor) 1204 and connection 1202 that couples various system components including system memory 1208, such as read-only memory (ROM) 1210 and random access memory (RAM) 1212 to processor 1204. Computing system 1200 can include a cache of high-speed memory 1206 connected directly with, in close proximity to, or integrated as part of processor 1204.

Processor 1204 can include any general purpose processor and a hardware service or software service, such as services 1216, 1218, and 1220 stored in storage device 1214, configured to control processor 1204 as well as a special-purpose processor where software instructions are incorporated into the actual processor design. Processor 1204 may essentially be a completely self-contained computing system, containing multiple cores or processors, a bus, memory controller, cache, etc. A multi-core processor may be symmetric or asymmetric.

To enable user interaction, computing system 1200 includes an input device 1226, which can represent any number of input mechanisms, such as a microphone for speech, a touch-sensitive screen for gesture or graphical input, keyboard, mouse, motion input, speech, etc. Computing system 1200 can also include output device 1222, which can be one or more of a number of output mechanisms known to those of skill in the art. In some instances, multimodal systems can enable a user to provide multiple types of input/output to communicate with computing system 1200. Computing system 1200 can include communication interface 1224, which can generally govern and manage the user input and system output. There is no restriction on operating on any particular hardware arrangement, and therefore the basic features here may easily be substituted for improved hardware or firmware arrangements as they are developed.

Storage device 1214 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1214 can include software services, servers, services, etc., that when the code that defines such software is executed by the processor 1204, it causes the system to perform a function. In some embodiments, a hardware service that performs a particular function can include the software component stored in a computer-readable medium in connection with the necessary hardware components, such as processor 1204, connection 1202, output device 1222, etc., to carry out the function.

For clarity of explanation, in some instances, the present technology may be presented as including individual functional blocks including functional blocks comprising devices, device components, steps or methods in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a computing device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

### ASPECTS

The present technology includes computer-readable storage mediums for storing instructions, and systems for executing any one of the methods embodied in the instructions addressed in the Aspects of the present technology presented below:

Aspect 1. A method comprising: receiving, by a sender AI agent instance, a first prompt from a sender user account requesting assistance with a task that requires interfacing with at least one recipient user account, wherein the sender AI agent instance is acting as a personal assistant to the sender user account; sending a message, by the sender AI agent instance, to the at least one recipient user account in furtherance of the task; receiving, by the sender AI agent instance, a reply from the recipient user account that is responsive to the message; and completing, by the sender AI agent instance, the task on behalf of the sender user account.

Aspect 2. The method of Aspect 1, further comprising: accessing an address book on behalf of the sender user account to identify an address at which to reach the recipient user account.

Aspect 3. The method of any one of Aspects 1-2, wherein an entry in the address book for the recipient user account includes an address to reach a recipient AI agent instance acting as a personal assistant on behalf of the recipient user account, and selecting the address of the recipient AI agent instance to which to send the message.

Aspect 4. The method of any one of Aspects 1-3, further comprising: after receiving the response from the recipient user account, providing, by the sender AI agent instance, a message pertaining to the reply from the recipient user account.

Aspect 5. The method of any one of Aspects 1-4, wherein the message pertaining to the reply requests permission from the sender user account to take an action on behalf of the sender user account.

Aspect 6. The method of any one of Aspects 1-5, further comprising: presenting a selectable user interface option to the sender user account to solicit the permission from the sender user account to take the action.

Aspect 7. The method of any one of Aspects 1-6, further comprising: generating a plan for an action to take to complete the task on behalf of the sender user account; and determining whether the sender AI agent instance has permission to take the action.

Aspect 8. The method of any one of Aspects 1-7, wherein the sender AI agent instance has access to a memory file associated with the sender user account that is configured to store persistent permissions given to the sender AI agent instance.

Aspect 9. The method of any one of Aspects 1-8, wherein the sender AI agent instance has access to a memory file which records personalization notes for the sender user account.

Aspect 10. The method ofany one of Aspects 1-9, wherein the at least one recipient user account utilizes a recipient AI agent instance as a personal assistant to the at least one recipient user account.

Aspect 11. The method of any one of Aspects 1-10, wherein the sender AI agent instance is configured to be able to communicate with the sender user account and the sender AI agent instance, but not the recipient user account.

Aspect 12. The method of any one of Aspects 1-11, wherein the recipient AI agent instance intercepts the message from the sender AI agent instance.

Aspect 13. The method of any one of Aspects 1-12, further comprising: determining by the recipient AI agent instance whether the sender user account or sender AI agent instance is on a block list of entities prohibited from sending messages to the recipient user account.

Aspect 14. The method of any one of Aspects 1-13, further comprising: after receiving the message from the sender user account, providing, by the recipient AI agent instance, a summary to the recipient user account pertaining to the message from the sender user account.

Aspect 15. The method of any one of Aspects 1-14, wherein the message from the sender AI agent instance to the recipient user account identifies the sender AI agent instance as an author of the message or at least identifies that the message is from an autonomous agent.

Aspect 16. The method of any one of Aspects 1-15, wherein the recipient AI agent instance intercepts the message when it determines that the author of the message is the sender AI agent instance, and would not intercept the message if the author of the message was the sender user account.

Aspect 17. The method of any one of Aspects 1-16, wherein the sender AI agent instance has access to an app utilized by the sender user account, wherein the completing the task on behalf of the sender user account involves the sender AI agent instance interacting with the app utilized by the sender user account.

Aspect 18. The method of any one of Aspects 1-17, wherein the sender AI agent instance utilizes credentials of the sender user account to access the app on behalf of the sender user account.

Aspect 19. The method of any one of Aspects 1-18, wherein the sender AI agent instance has access to a security token that gives it access to the app on behalf of the sender user account.

Aspect 20. A method comprising: intercepting by a sender AI agent instance, a message from a recipient user account addressed to a sender user account, wherein the sender AI agent instance is acting as a personal assistant to the sender user account, the sender AI agent instance would not intercept the message if the author of the message was the recipient user account; determining by the sender AI agent instance whether the recipient user account is on a block list of entities prohibited from sending messages to the sender user account; when the recipient user account is not on a block list, generating a plan for a reply to provide on behalf of the sender user account; determining whether the sender AI agent instance has permission to reply, wherein the determining whether the sender AI agent instance has permission includes looking for an explicit permission previously provided and recorded in a memory file for the sender user account, wherein the determining whether the sender AI agent instance has permission includes deciding, by the sender AI agent instance that the generated plan is of a character such that the sender user account would want to be informed of the plan before the sender AI agent instance carries out the plan; when the sender AI agent instance does not have permission to reply, presenting the plan for the reply to the sender user account with a request for permission to carry out the plan, and when the sender AI agent instance has permission to carry out the plan, replying to the recipient user account according to the plan with a reply that is responsive to the message from the recipient user account.

1. A method comprising:
receiving, by a sender AI assistant instance, a first prompt from a sender user account, the first prompt comprising an instruction to complete a task that requires interfacing with at least one recipient user account, and wherein the sender AI assistant instance is configured to be able to communicate with the sender user account and a recipient AI assistant instance, but not the at least one recipient user account and wherein the sender AI assistant instance and the recipient AI assistant instances are instances of one or more generative response engines, wherein the one or more generative response engines receive prompts and contexts as inputs and generate outputs based on the inputs by sampling tokens based on a probability distribution;
transmitting a message, by the sender AI assistant instance, to the at least one recipient user account, wherein the message is output by the sender AI assistant instance based on the first prompt;
intercepting, by the recipient AI assistant instance, the message based on the message containing metadata indicating that the message was generated by an AI assistant instance;
implicitly gaining, by the recipient AI assistant instance from an interaction with the at least one recipient user account, permission to respond to the sender AI assistant instance;
receiving, by the sender AI assistant instance from the recipient AI assistant instance, a reply from the at least one recipient user account that is responsive to the message; and
completing, by the sender AI assistant instance, the task on behalf of the sender user account.

2. The method of claim 1, further comprising:
after receiving the response from the at least one recipient user account, providing, by the sender AI assistant instance, a message pertaining to the reply from the at least one recipient user account.

3. The method of claim 2, wherein the message pertaining to the reply requests permission from the sender user account to take an action on behalf of the sender user account.

4. The method of claim 3, further comprising:
presenting a selectable user interface option to the sender user account to solicit the permission from the sender user account to take the action.

5. The method of claim 1, further comprising:
generating a plan for an action to take to complete the task on behalf of the sender user account; and
determining whether the sender AI assistant instance has permission to take the action.

6. The method of claim 1, wherein the sender AI assistant instance has access to a memory file which records personalization notes for the sender user account.

7-9. (canceled)

10. The method of claim 1, wherein the sender AI assistant instance has access to an app utilized by the sender user account, wherein the completing the task on behalf of the sender user account involves the sender AI assistant instance interacting with the app utilized by the sender user account.

11. A method comprising:
intercepting by a sender AI agent instance, a message from a recipient user account addressed to a sender user account, wherein the sender AI agent instance is acting as a personal assistant to the sender user account;
determining by the sender AI agent instance whether the recipient user account is on a block list of entities prohibited from sending messages to the sender user account;
when the recipient user account is not on a block list, generating a plan for a reply to provide on behalf of the sender user account;
determining whether the sender AI agent instance has permission to reply;
when the sender AI agent instance does not have permission to reply, presenting the plan for the reply to the sender user account with a request for permission to carry out the plan, and
when the sender AI agent instance has permission to carry out the plan, replying to the recipient user account according to the plan with a reply that is responsive to the message from the recipient user account.

12. A computing system comprising:
at least one processor; and
a memory storing instructions that, when executed by the at least one processor, configure the computing system to:
receive, by a sender AI assistant instance, a first prompt from a sender user account the first prompt comprising an instruction to complete with a task that requires interfacing with at least one recipient user account, and wherein the sender AI assistant instance is configured to be able to communicate with the sender user account and a recipient AI assistant instance, but not the at least one recipient user account and wherein the sender AI assistant instance and the recipient AI assistant instances are instances of one or more generative response engines, wherein the one or more generative response engines receive prompts and contexts as inputs and generate outputs based on the inputs by sampling tokens based on a probability distribution;
transmit a message, by the sender AI assistant instance, to the at least one recipient user account, wherein the message is output by the sender AI assistant instance based on the first prompt;
intercept, by the recipient AI assistant instance, the message based on the message containing metadata indicating that the message was generated by an AI assistant instance;
implicitly gain, by the recipient AI assistant instance from an interaction with the at least one recipient user account, permission to respond to the sender AI assistant instance;
receive, by the sender AI assistant instance, a reply via the recipient AI assistant instance from the at least one recipient user account that is responsive to the message; and
complete, by the sender AI assistant instance, the task on behalf of the sender user account.

13. The computing system of claim 12, wherein the instructions further configure the computing system to:
after receiving the response from the at least one recipient user account, provide, by the sender AI assistant instance, a message pertaining to the reply from the at least one recipient user account.

14. The computing system of claim 13, wherein the message pertains to the reply requests permission from the sender user account to take an action on behalf of the sender user account.

15. The computing system of claim 12, wherein the instructions further configure the computing system to:
generate a plan for an action to take to complete the task on behalf of the sender user account; and
determine whether the sender AI assistant instance has permission to take the action.

16. The computing system of claim 12, wherein the sender AI assistant instance has access to a memory file which records personalization notes for the sender user account.

17-18. (canceled)

19. The computing system of claim 12, wherein the sender AI assistant instance has access to an app utilized by the sender user account, wherein the completing the task on behalf of the sender user account involves the sender AI assistant instance interacting with the app utilized by the sender user account.

20. A non-transitory computer-readable storage medium comprising instructions that when executed by at least one processor, cause the at least one processor to:
intercept by a sender AI agent instance, a message from a recipient user account addressed to a sender user account, wherein the sender AI agent instance is acting as a personal assistant to the sender user account;
determine by the sender AI agent instance whether the recipient user account is on a block list of entities prohibited from sending messages to the sender user account;
when the recipient user account is not on a block list, generate a plan for a reply to provide on behalf of the sender user account;
determine whether the sender AI agent instance has permission to reply;
when the sender AI agent instance does not have permission to reply, present the plan for the reply to the sender user account with a request for permission to carry out the plan, and
when the sender AI agent instance has permission to carry out the plan, reply to the recipient user account according to the plan with a reply that is responsive to the message from the recipient user account.

21. The method of claim 1, wherein gaining permission to respond to the sender AI assistant instance comprises:
providing, by the recipient AI assistant instance to the recipient user account, a summary of the message from the sender AI assistant instance; and
receiving, by the recipient AI assistant instance, a response from the recipient user account, wherein the response implies permission for the recipient AI assistant instance to act on the response in furtherance of the task.

22. The method of claim 1, wherein completing, by the sender AI assistant instance, the task on behalf of the sender user account comprises:
generating, by the sender AI assistant instance, a response based on completing the task by sampling tokens from a probability distribution.

23. The computing system of claim 12, wherein gaining permission to respond to the sender AI assistant instance comprises:
providing, by the recipient AI assistant instance to the recipient user account, a summary of the message from the sender AI assistant instance; and
receiving, by the recipient AI assistant instance, a response from the recipient user account, wherein the response implies permission for the recipient AI assistant instance to act on the response in furtherance of the task.

24. The computing system of claim 12, wherein the sender AI assistant instance completes the task on behalf of the sender user account by:
generating, by the sender AI assistant instance, a response based on completing the task by sampling tokens from the probability distribution.

25. The method of claim 1, wherein the message posted to a workspace accessible to the sender AI assistant instance and the recipient AI assistant instance such that the sender AI instance and the recipient AI assistant instance can communicate in a channel of the workspace in furtherance of the task.

26. The method of claim 25, wherein completing the task on behalf of the sender account comprises invoking a task agent to complete at least a portion of the task, wherein the task agent has access to messages in the channel.

27. A non-transitory computer-readable storage medium comprising instructions that when executed by at least one processor, cause the at least one processor to:
receive, by a sender AI assistant instance, a first prompt from a sender user account the first prompt comprising an instruction to complete with a task that requires interfacing with at least one recipient user account, and wherein the sender AI assistant instance is configured to be able to communicate with the sender user account and a recipient AI assistant instance, but not the at least one recipient user account and wherein the sender AI assistant instance and the recipient AI assistant instances are instances of one or more generative response engines, wherein the one or more generative response engines receive prompts and contexts as inputs and generate outputs based on the inputs by sampling tokens based on a probability distribution;
transmit a message, by the sender AI assistant instance, to the at least one recipient user account, wherein the message is output by the sender AI assistant instance based on the first prompt;
intercept, by the recipient AI assistant instance, the message based on the message containing metadata indicating that the message was generated by an AI assistant instance;
implicitly gain, by the recipient AI assistant instance from an interaction with the at least one recipient user account, permission to respond to the sender AI assistant instance;
receive, by the sender AI assistant instance, a reply via the recipient AI assistant instance from the at least one recipient user account that is responsive to the message; and
complete, by the sender AI assistant instance, the task on behalf of the sender user account.

28. The method of claim 1, wherein the message and the reply are provided as input to the sender AI assistant instance in a context window of the sender AI assistant instance.

29. The method of claim 1, wherein completing the task on behalf of the sender user account comprises calling a function via an API in furtherance of the task, wherein a function call is output by the sender AI assistant instance based, at least in part, on the first prompt and a conversation thread comprising the message and the reply.
